(19) United States
(12) Patent Application Publication
(10) Pub. No.: US 2002/0071877 A1
(43) Pub. Date: Jun. 13, 2002

(54) Heaven scent

(76) Inventor: Nancy Joy Mueller, Livermore, CA (US)

Correspondence Address: Nancy J. Mueller, PO Box 1104, Livermore, CA, 94551-1104, US

(21) Appl. No.: 10/041,520

(22) Filed: Jan. 7, 2002

Related U.S. Application Data
(60) Provisional application No. 60/246,884, filed on Nov. 8, 2000.

(51) Int. Cl. C08L 1/18

(52) U.S. Cl. 424/747; 106/169.18

(57) ABSTRACT

This invention involves the use of Mentha spicata or Mentha cardiaca (spearmint) oil as a deer repellent.

The spearmint oil is mixed with an oil extender/sticker. This mixture is added to water and then sprayed onto the foliage.

The result is that the deer are repelled by the odor of the herb and are kept from eating the plants which have been sprayed.

### BACKGROUND OF THE INVENTION

On Dec. 15^{th}, 1999, I read an article about using spearmint plants in garden landscapes to help keep deer from eating and damaging other plants in the garden. The odor from the spearmint plants repels the deer, but the deer need to step onto the spearmint plants to release the oil before it is effective. Spearmint plants would need to be planted by each landscape bush but the deer could still eat large amounts of foliage before being repelled by the odor rising from crushed plants. It occurred to me that this is an ineffective means of introduction of the spearmint odor to the deer and that a foliar spray of the Mentha spicata or Mentha cardiaca (spearmint) oil would be far more effective and produces a much more efficient repellent.

I mixed spearmint oil with a natural or petroleum based extender/sticker, the commercial Volk oil from Ortho initially, then generic mineral oil, Soybean oil or olive oil can also be used. I added this mixture to water and sprayed it onto foliage. The advantage of spearmint oil as the active ingredient is that it is natural herb oil.

In February 2000 an opportunity to test the spearmint formula arose. The formula was mixed in the ratio of 2 fluid ounces of spearmint oil to 1 gallon of water, with commercial medium weight mineral oil as the spreader. It was applied by a spray device. From my horticultural background, I know foliar sprays should be applied at temperatures between 85 and 40 degrees F.

Vegetation which had been previously eaten and damaged by deer was sprayed. The result of the application of the spearmint foliar spray was the immediate repelling of the deer. New growth appeared on previously damaged vegetation. The new growth continued to mature, followed by budding and blooming of flowering plants. Spraying continued on a weekly schedule for the remainder of the growing season.

The spearmint concentrate formula proved itself to be effective throughout all seasons of the year. Each spraying was effective for 7-10 days. The deer showed no signs of tolerance to the product.

The spearmint oil repellent is all natural, non-toxic and environmentally friendly. There is no damage to plant foliage when the formula is applied as previously indicated between 40 and 85 degrees F.

Other deer repellents products are not edible, may damage foliage by burning and lose effectiveness within a short period of time after application.

### SUMMARY

The idea for this Mentha spicata or Mentha cardiaca (spearmint) deer repellent came to me after reading some information regarding this herb.

The spearmint oil is mixed with an oil based extender/sticker. This mix is added to water and sprayed onto foliage. The result is that the odor from the spearmint oil repels the deer, keeping them from eating plants which have been sprayed.

The spearmint mixture has many advantages. It is all natural, non-toxic and pleasant to work with. It is long lasting, remaining effective for 7-10 days between applications and the deer do not become immune to the odor. The repellent can be safely applied to edible vegetation (fruit and vegetables) as well as to ornamental plants if used as directed.

### DESCRIPTION

The formula for the spearmint oil based repellent is:

54% oil extender/sticker e.g. mineral oil, commercial Volk Oil, soybean oil or olive oil.

38% spearmint oil—Mentha spicata or Mentha cardiaca

8% water

This makes a concentrated liquid.

To use the concentrate, it must be mixed with more water, at the rate of 2 fluid ounces of spearmint concentrate to 1 gallon water.

Fill the sprayer device and spray the mixture onto the foliage of vegetation to be protected from deer damage.

The repellent mixture can be applied during the growing season as well as to dormant plants.

To prevent foliage burn, use the repellent only when the temperature is between 40 and 85 degrees F.

The spearmint repellent is non-toxic to deer and to humans and may be safely used on all edible vegetation. The MSDS (Medical Statistical Data Sheets) show that spearmint oil is non-toxic. When used in this Heaven Scent (trademark protection pending) Deer Repellent formula with other non-toxic, natural ingredients, the product is non-toxic, natural and safe to use.

### OPERATION

The concentrated spearmint oil deer repellent, Heaven Scent is mixed with water in the ratio of 2 fluid ounces repellent to 1 gallon of water. This mixture is then sprayed on vegetation to be protected from the deer.

One gallon of spray mixture wetting the top surface of the foliage, will cover 5000 sq. feet.

The odor of the spearmint affects the deer's olfactory sense, it repulses the deer and they will not eat the foliage.

### CONCLUSIONS, RAMIFICATIONS AND SCOPE

On Dec. 15, 1999 I read an article in a magazine which stated that planting Mentha spicata or Mentha cardiac (spearmint) among landscape plants helps keep deer away, as the odor of the spearmint had a repulsive effect on the deer olfactory sense.

It occurred to me that a foliage spray of the Mentha spicata or Mentha cardiaca would be more effective. I mixed 54% oil based extender/sticker to 38% commercially pure spearmint oil with 8% water to formulate the concentrate. This spearmint concentrate is then mixed with additional water at the rate of 2 fluid ounces concentrate to 1 gallon water. The diluted mixture can then be applied from spraying devices to the vegetation. As a result of the application, deer will no longer eat or damage the vegetation.

This product has been tested at the same site for more than 2 growing seasons and the deer are still repelled by this spearmint formula. The repellent has maintained its effectiveness.

The odor of the spearmint repellent is offensive to the deer olfactory sense, causing them to avoid plants sprayed with the mixture.

Although literature is full of references for medical/cosmetic/food uses of spearmint oil, my research did not turn up any previous use of Mentha spicata or Mentha cardiaca (spearmint) for deer or animal repellents. Other deer repellents use different flavor and odor active ingredients, including seaweed, fish oil, blood meal and animal urine

The ramifications of this natural, safe, deer repellent formula are enormous—from agri-business, ornamental landscaping, forestry and park departments to private gardens near open land.

I envision safety as well as crop and landscape benefits. Deer crossing of roadways on their migratory routes have been a traffic hazard for years. This repellent can be beneficial in helping to reroute the deer to safer crossings. Deer damage to food crops is enormous and this large economic loss can be eased by using this product.

I feel that the liquid spearmint product or Carvone, the major component of these oils, can be formulated into an emulsified, time-released concentrate, increasing the time between sprayings.

There is also potential for time release encapsulated granules of the spearmint product which could be broadcast over wide areas—deer hooves would crush the granules and release the oils as they approach treated areas, so keeping the deer from areas as desired.

There can be no limit to effectual forms of benefit this can have.

1. I claim the formulation and all that comprises the use of Mentha spicata and Mentha cardiaca (spearmint) oils as a deer repellent.

2. The use of these oils in claim #1, whether from natural or synthetic sources.

3. The use of Carvone, either (R) (−)-carvone [648540-1] or (s) (+)-carvone [2244-16-8] in claim #1 whether natural or synthetic sources.

4. I claim this formula and the use of spearmint oil as a deer repellent where the active oil is mixed with other agents for the purpose of establishing a water/oil emulsion.

5. I claim the use of the repellent claimed in claim #'s 1 and 4 where the application of the formula includes foliar spray, systemic release pellets, ground spread granules, and time release encapsulation-emulsification.

6. 1 claim the use of the repellent claimed in claim #'s 1 and 4 where the active ingredients are bound to landscaping fabric, cardboard, or a suitable material to attach to a trunk of a tree or structure that deer may rub their antlers on and cause damage. When the antlers are rubbed on encapsulated formula bonded to the material, the odor which repels the deer will be released and repel them from the tree or structure.

7. 1 claim the use of oils in claims #1-3 whereby they also impart anti-fungal benefits to the plants.

8. I claim the use of rosemary oil, caraway seed oil, lavender oil, oregano oil thyme oil and spearmint oil as use in a repellent for deer and other animals.

9. The use of these oils in claim #8, whether from natural or synthetic sources.

10. I claim this formula and the use of the oils in claim #8 as a deer repellent where the active oil is mixed with other agents for the purpose of establishing a water/oil emulsion.

11. The use of repellents claimed in claim #'s 8 and 10, where the application is the same as claim #5.

12. The use of the repellents claimed in #1 through #10 where the active ingredients are rosemary oil, caraway seed oil, lavender oil, oregano oil thyme oil and spearmint oil or carvone as use in a repellent for deer and other animals.

13. I claim the benefit of the claim filing date of the provisional priority, Co-pending filed on November 2000, filing No. 60/246884.
